(19) United States
(12) Patent Application Publication
(10) Pub. No.: US 2006/0023893 A1
(43) Pub. Date: Feb. 2, 2006

(54) Sound apparatus, sound system and method of correcting sound signal

(75) Inventor: Tomoaki Abe, Yokohama-shi (JP)

Correspondence Address: RATNERPRESTIA, P O BOX 980, VALLEY FORGE, PA, 19482-0980, US

(73) Assignee: Matsushita Electric Industrial Co., Ltd.

(21) Appl. No.: 11/179,299

(22) Filed: Jul. 12, 2005

(30) Foreign Application Priority Data
Jul. 30, 2004 (JP) P2004-223178

(51) Int. Cl. H04R 29/00

(52) U.S. Cl. 381/59; 381/56; 381/58

(57) ABSTRACT

A sound apparatus includes a correction unit that has an input section for inputting an electric signal and a correction section for correcting a sound signal based on the electric signal inputted to the input section, and a connection unit that connects a speaker to the input section of the correction unit.

### BACKGROUND OF THE INVENTION

This invention relates to a sound apparatus having a plurality of loudspeakers and more particularly to an indoor audio apparatus, a car-installed audio apparatus, a vehicle in which an audio apparatus is built, etc, a sound system and a method of correcting a sound signal.

An interior frequency response characteristic correction system including a frequency response characteristic calculation section for calculating the spatial frequency characteristic of a vehicle based on the measurement signal from a microphone is known as a sound apparatus in a related art. (For example, refer to JP-A-08-125473 (page 4, FIG. 3)) An audio system including a signal processing section for receiving a sound signal collected by a microphone as digital sound collection data and making a frequency response characteristic correction, etc., for each channel is also known as a sound apparatus in a related art. (For example, refer to JP-A-2002-330499 (page 5, FIG. 1)).

Further, an in-bathroom sound apparatus including a digital signal processor for automatically calculating a correction coefficient based on sound data collected by a microphone and correcting an audio signal using the calculated correction coefficient is known as a sound apparatus in a related art. (For example, JP-A-2004-77657 (page 6, FIG. 5))

However, in the related sound apparatus, the sound data collected by a microphone is used to correct the audio signal and therefore the difference between the resonance characteristic of the microphone and that of a loudspeaker has an effect on the correction of the audio signal; this is a problem.

Particularly, if a plurality of loudspeakers are installed in a comparatively small space of a cabin, etc., one loudspeaker receives a sound output from another loudspeaker and resonance is easily produced and therefore it becomes important to reflect the resonance characteristic of each loudspeaker on the correction of the audio signal to realize a clear sound field in a comparatively narrow space.

### SUMMARY OF THE INVENTION

It is therefore an object of the invention to provide a sound apparatus, a sound system and a method of correcting a sound signal, that can realize a clear sound field.

In order to achieve the above object, according to the present invention, there is provided a sound apparatus, comprising:

a correction unit that includes an input section for inputting an electric signal and a correction section for correcting a sound signal based on the electric signal inputted to the input section; and

a connection unit that connects a speaker to the input section of the correction unit.

Preferably, the correction unit includes an output section for outputting the sound signal corrected by the correction section. The connection unit is configured to switch the speaker between an input connection for connecting the speaker to the input section and an output connection for connecting the speaker to the output section.

Preferably, the electric signal inputted to the input section from the speaker corresponds to a test sound which is received by the speaker and is outputted from other speaker. The other speaker is not connected to the input section of the correction unit.

Preferably, the correction unit includes a calculation section for calculating a resonance characteristic of the speaker by using the electric signal from the speaker. The correction section corrects the sound signal outputted from a sound source based on the resonance characteristic.

Here, it is preferable that, a vehicle comprising the sound apparatus.

Here, it is preferable that, a sound system, comprising:

a sound source;

a first speaker;

a correction unit that is connected to the first speaker;

wherein the correction unit corrects a sound signal from the sound source based on an electric signal inputted from the first speaker.

Preferably, the sound system further comprises a connection unit that connects the correction unit to the first speaker. The correction unit includes an input section for inputting the electric signal and an output section for outputting the corrected sound signal. The connection unit is configured to switch the first speaker between an input connection for connecting the first speaker to the input section and an output connection for connecting the first speaker to the output section.

Preferably, the sound system further comprises a second speaker that outputs a test sound. The electric signal inputted to the correction unit from the first speaker corresponds to the test sound which is received by the first speaker.

Preferably, the correction unit includes a calculation section for calculating a resonance characteristic of the first speaker by using the electric signal from the first speaker. The correction section corrects the sound signal outputted from the sound source based on the resonance characteristic.

Here, it is preferable that a method of correcting a sound signal, comprising:

providing a correction unit that includes an input section, an output section, and a correction section;

connecting a speaker to the input section;

receiving a test sound by the speaker;

inputting an electric signal that corresponds to the test sound, into the input section;

correcting a sound signal from a sound source based on the inputted electric signal; and

outputting the corrected sound signal.

Preferably, the method further comprises:

switching the speaker between an input connection for connecting the speaker to the input section and an output connection for connecting the speaker to the output section.

Preferably, the method further comprises:

outputting a signal for connecting the speaker to the input section for correcting the sound signal; and

outputting a signal for a request of outputting test sound from a different speaker being not connected to the input section.

Preferably, the method further comprises:

calculating a resonance characteristic of the speaker by using the electric signal from the speaker;

correcting the sound signal outputted from the sound source based on the resonance characteristic.

According to the configurations and methods, an electric signal output by the loudspeaker receiving a sound wave is input to the correction unit, which then uses the electric signal from the loudspeaker to correct the sound signal from the sound source.

The invention can provide the sound apparatus that includes the connection unit for connecting the loudspeaker to the input section of the correction unit and can realize a clear sound field.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a block diagram to show the configuration of a sound apparatus according to an embodiment of the invention;

FIG. 2 is a drawing to show the positional relationship between loudspeakers in a vehicle in the embodiment of the invention;

FIG. 3A is a drawing to show output connection of connection circuit and FIG. 3B is a drawing to show input connection of connection circuit;

FIG. 4 is a flowchart to show the operation of a control circuit in the embodiment of the invention;

FIG. 5 is a flowchart to show the operation of a correction circuit in the embodiment of the invention; and

FIG. 6 is a drawing to show the component of a sound signal corresponding to a resonance frequency.

### DETAILED DESCRIPTION OF THE PREFERRED EMBODIMENTS

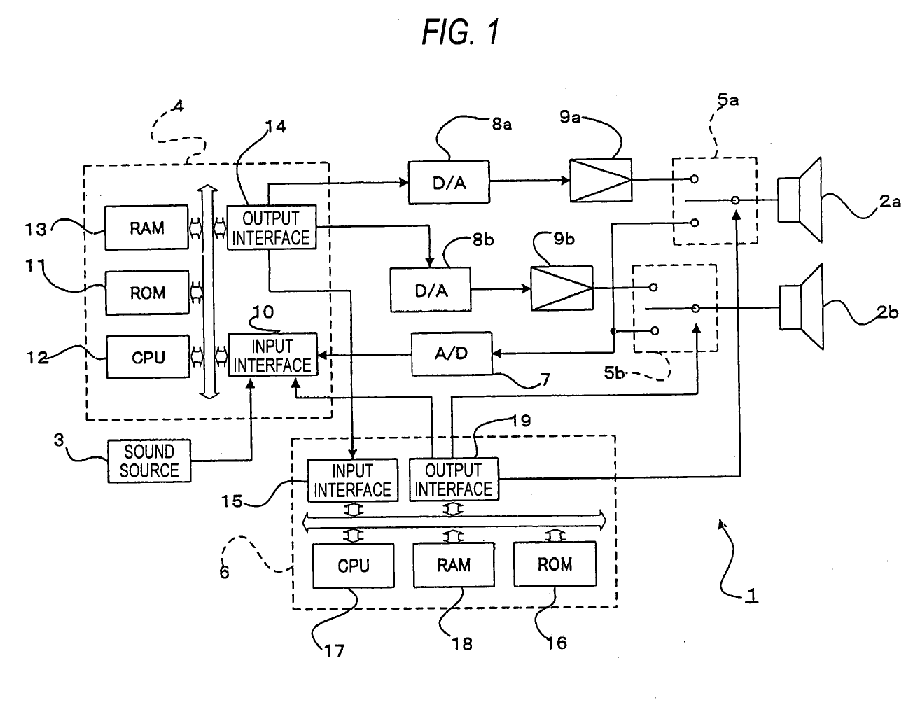

An embodiment of a sound apparatus according to the invention will be discussed with reference to FIGS. 1 to 6. First, the configuration of the sound apparatus according to the embodiment will be discussed with reference to FIGS. 1 to 3.

As shown in FIG. 1, a sound apparatus 1 includes loudspeakers 2, a correction circuit 4 for correcting a sound signal from a sound source 3 in response to an electric signal from each loudspeaker 2, connection circuits 5 for connecting the loudspeakers 2 and the correction circuit 4, a control circuit 6 for controlling the correction circuit 4 and the connection circuits 5, an analog-digital converter (A/D) 7 for converting the electric signal from each loudspeaker 2 from analog form into digital form, digital-analog converters (D/A) 8 for converting the sound signal from the correction circuit 4 from digital form into analog form, and amplifiers 9 for amplifying the sound signal from the D/A 8.

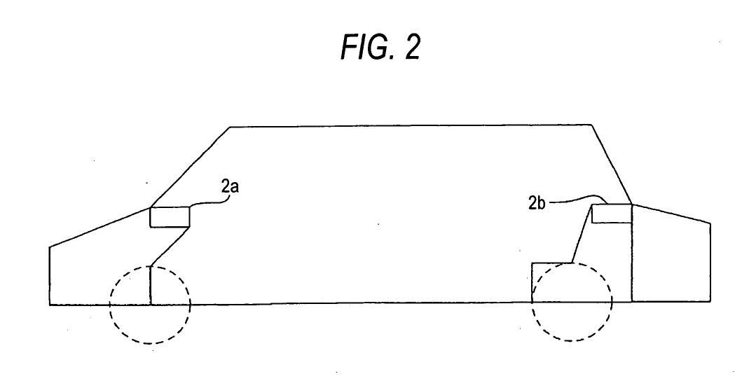

As shown in FIG. 2, loudspeakers 2a and 2b are installed on the front of the inside of a vehicle, in the rear of the inside of a vehicle, etc. Of course, the loudspeakers 2a and 2b may be built in the ceiling of a vehicle in a state in which they are adjacent to each other.

The correction circuit 4 includes an input interface (input I/F) 10 for inputting the sound signal from the sound source 3, various control signals from the control circuit 6, and the electric signal from the A/D 7, a ROM 11 storing a correction program for correcting various signals input through the input I/F 10, a CPU 12 for executing the correction program stored in the ROM 11 and processing various signals, a RAM 13 for storing the processing result of the CPU 12, etc., and an output I/F 14 for outputting the processing result, etc., stored in the RAM 13 to the control circuit 6 and the D/A 8. The input I/F 10 and the output I/F 14 correspond to an input section and an output section respectively. The ROM 11, the CPU 12, and the RAM 13 correspond to a correction section.

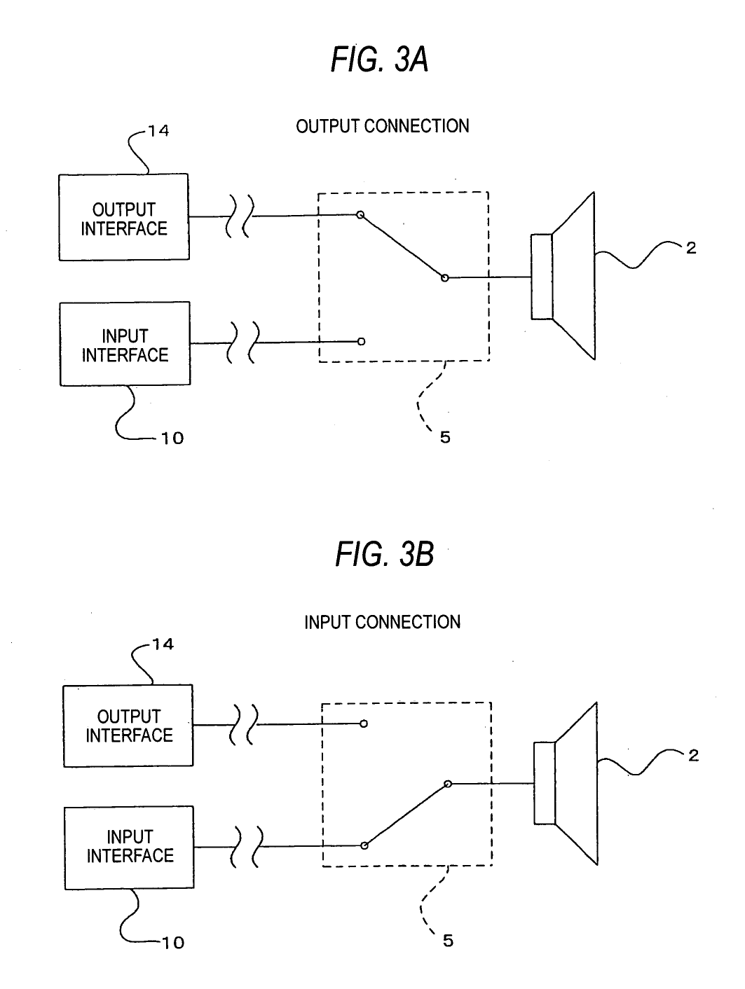

As shown in FIG. 3, the connection circuit 5 is implemented as a relay circuit, etc., and can switch between output connection for connecting the loudspeaker 2 to the output I/F 14 of the correction circuit 4 (see FIG. 3A) and input connection for connecting the loudspeaker 2 to the input I/F 10 of the correction circuit 4 (see FIG. 3B) in response to various control signals from the control circuit 6. Of course, the connection circuit 5 may be switched between the output connection and the input connection as the user operates the apparatus.

In the embodiment, the connection circuit for switching between the output connection and the input connection is provided, but connection circuit for continuously connecting the loudspeaker 2 to the output I/F 14 of the correction circuit 4 and the input I/F 10 of the correction circuit 4 may be used.

The control circuit 6 includes an input I/F 15 for inputting the processing result of the correction circuit, a ROM 16 storing a control program for controlling the correction circuit 4 and the connection circuits 5, a CPU 17 for executing the control program stored in the ROM 16 and generating various control signals, a RAM 18 for storing the processing result input through the input I/F 15, various control signals from the CPU 17, etc., and an output I/F 19 for outputting the various control signals, etc., stored in the RAM 18 to the correction circuit 4 and the connection circuits 5.

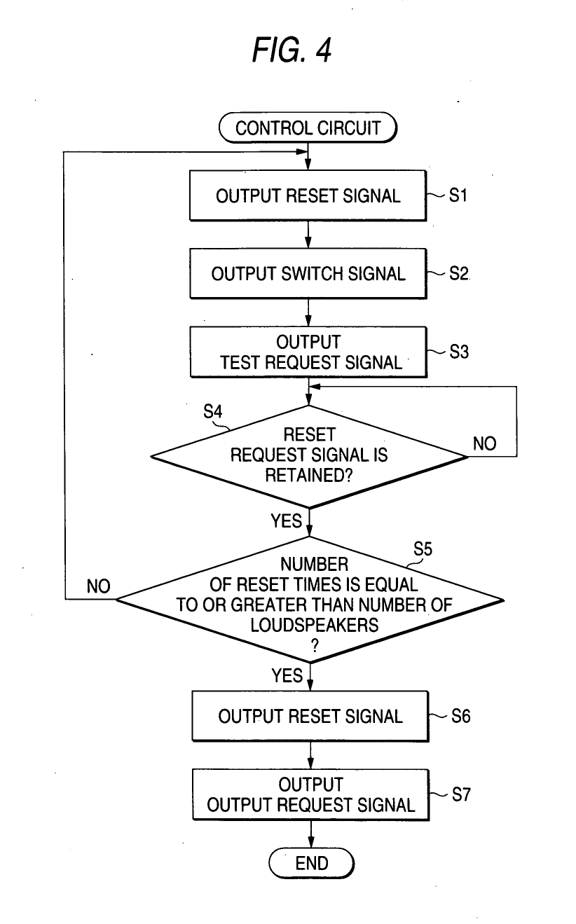

The operation of the described sound apparatus 1 will be discussed with reference to FIGS. 4 to 6. First, the operation of the control circuit 6 will be discussed with reference to FIG. 4.

As shown in FIG. 4, when power is turned on, the CPU 17 executes the control program stored in the ROM 16 and outputs a reset signal through the output I/F 19 for placing the connection circuits 5a and 5b in output connection (step S1).

When the reset signal is output, the CPU 17 executes the control program stored in the ROM 16 and outputs a switch signal through the output I/F 19 for placing either of the connection circuits 5a and 5b in input connection (step S2). At this time, a history as to whether or not each connection circuit 5 is placed in input connection is retained in the RAM 18 as a signal. If a switch signal is again output, the connection circuit 5 not placed in input connection is switched into input connection.

When the switch signal is output at step S2, the CPU 17 executes the control program stored in the ROM 16 and outputs a test request signal through the output I/F 19 for making a request for outputting a test audio signal (step S3). After output through the output I/F 19, the test request signal is input to the correction circuit 4 through the input I/F 10.

After the test request signal is output, the CPU 17 executes the control program stored in the ROM 16 and determines whether or not a reset request signal for making a request for placing the connection circuits 5a and 5b in output connection is retained in the RAM 18 (step S4). The reset request signal is a signal output by the correction circuit 4 and then input to the RAM 18 through the input I/F 15.

If the CPU determines at step S4 that the reset request signal is not retained in the RAM 18 (NO at S4), the CPU 17 executes the control program stored in the ROM 16 and again determines whether or not a reset request signal is retained in the RAM 18 after the expiration of a predetermined time interval.

On the other hand, if the CPU determines at step S4 that the reset request signal is retained in the RAM 18 (YES at S4), the CPU 17 executes the control program stored in the ROM 16 and determines whether or not the number of times the reset signal has been output is equal to or greater than the number of the installed loudspeakers 2 (step S5). The signal indicating the number of the installed loudspeakers 2 is previously retained in the RAM 18 as the user operates the apparatus, or is stored in the ROM 16 at the factory shipment time. The signal indicating the reset signal output history is retained in the RAM 18. This means that a comparison is made between the signal indicating the reset signal output history and the signal indicating the number of the installed loudspeakers 2 for determining whether or not the number of times the reset signal has been output is equal to or greater than the number of the installed loudspeakers 2.

If the CPU determines at step S5 that the number of times the reset signal has been output is smaller than the number of the installed loudspeakers 2 (NO at S5), the CPU 17 executes the control program stored in the ROM 16 and again executes steps S1 to S5.

On the other hand, if the CPU determines at step S5 that the number of times the reset signal has been output is equal to or greater than the number of the installed loudspeakers 2 (YES at S5), the CPU 17 executes the control program stored in the ROM 16 and outputs a reset signal through the output I/F 19 for placing the connection circuits 5a and 5b in output connection (step S6).

When the reset signal is output at step S6, the CPU 17 executes the control program stored in the ROM 16 and outputs an output request signal through the output I/F 19 for making a request for outputting a sound signal from the sound source 3 (step S7).

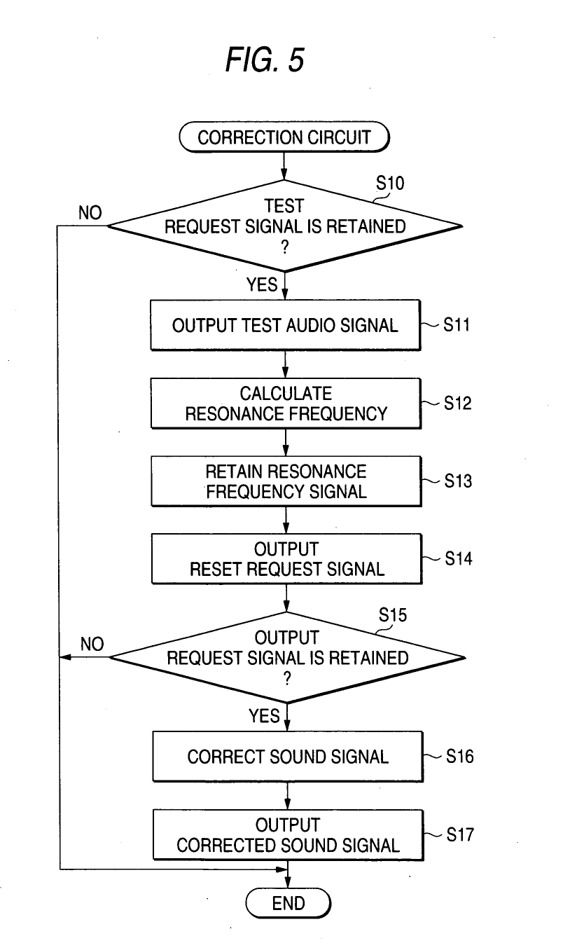

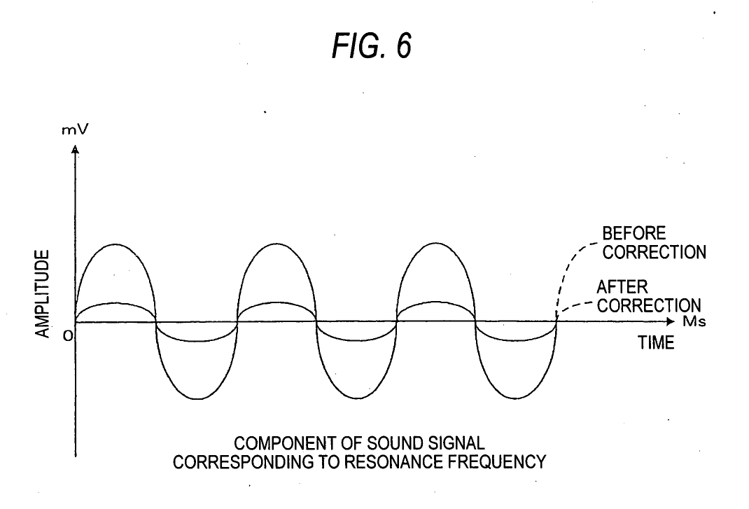

Next, the operation of the correction circuit 4 will be discussed with reference to FIGS. 5 and 6. As shown in FIG. 5, the CPU 12 executes the correction program stored in the ROM 11 and determines whether or not a test request signal is retained in the RAM 13 (step S10). The test request signal is a signal output by the control circuit 6 and then retained in the RAM 13 through the input I/F 10.

If the CPU 12 determines at step S10 that a test request signal is retained in the RAM 13 (YES at S10), the CPU 12 executes the correction program stored in the ROM 11 and outputs the test audio signal stored in the ROM 11 through the output I/F 14 (step S11). At this time, the loudspeaker 2 connected to the output I/F 14 outputs test audio corresponding to the test audio signal. On the other hand, the loudspeaker 2 connected to the input I/F 10 receives the test audio output by the loudspeaker 2 connected to the output I/F 14 and outputs an electric signal. This electric signal is input to the correction circuit 4 through the input I/F 10.

After the test audio signal is output, the CPU 12 executes the correction program stored in the ROM 11 and calculates the resonance frequency of the loudspeaker 2 connected to the input I/F 10 (step S12). The resonance frequency is calculated by disassembling the electric signal from the loudspeaker 2 into frequency components by Fourier transform and determining the frequency component having the largest amplitude and the frequency component roughly 180 degrees out of phase.

When the resonance frequency is calculated, the CPU 12 executes the correction program stored in the ROM 11 and retains a resonance frequency signal indicating the calculated resonance frequency in the RAM 13 (step S13).

When the resonance frequency signal is retained, the CPU 12 executes the correction program stored in the ROM 11 and outputs a reset request signal through the output I/F 14 for making a request for placing the connection circuits 5a and 5b in output connection (step S14).

After the reset request signal is output, the CPU 12 executes the correction program stored in the ROM 11 and determines whether or not an output request signal for making a request for outputting a sound signal is retained in the RAM 13 (step S15). The output request signal is a signal output by the control circuit 6 and retained in the RAM 13 through the input I/F 10 after calculation of the resonance frequencies of the loudspeakers 2a and 2b.

If the CPU 12 determines at step S15 that an output request signal is retained in the RAM 13 (YES at S15), the CPU 12 executes the correction program stored in the ROM 11 and uses the resonance frequency signal retained in the RAM 13 to correct the sound signal from the sound source 3 (step S16). Specifically, the sound signal is disassembled into frequency components by Fourier transform and the component corresponding to the resonance frequency of the loudspeaker 2 is determined from among the frequency components of the sound signal. The amplitude value of the determined frequency component is decreased to a lower value than the original value, as shown in FIG. 6.

When the sound signal is corrected, the CPU 12 executes the correction program stored in the ROM 11 and outputs the corrected sound signal through the output I/F 14 (step S17). At this time, the loudspeakers 2a and 2b output audio corresponding to the corrected audio (sound) signal.

If the CPU 12 determines at step S10 that a test request signal is not retained in the RAM 13 (NO at S10) or if the CPU 12 determines at step S15 that an output request signal is not retained in the RAM 13 (NO at S15), the CPU 12 executes the correction program stored in the ROM 11 and terminates the correction processing, etc.

As described above, according to the embodiment, the electric signal from each loudspeaker 2 is input to the correction circuit, so that the resonance characteristic of the loudspeaker 2 is reflected on correction processing of the sound signal and a clear sound field can be realized.

According to the embodiment, the loudspeaker 2 is used in place of a microphone, so that the cost can be reduced and the space in the cabin can be used effectively as compared with the case where the loudspeaker 2 and a microphone are provided separately.

As described above, the sound apparatus according to the invention has the advantage that it can realize a clear sound field, and is useful as an indoor audio apparatus, a car-installed audio apparatus, a vehicle in which an audio apparatus is built, etc.

Although the present invention has been shown and described with reference to specific preferred embodiments, various changes and modifications will be apparent to those skilled in the art from the teachings herein. Such changes and modifications as are obvious are deemed to come within the spirit, scope and contemplation of the invention as defined in the appended claims.

The present application is based on Japan Patent Application No. 2004-223178 filed on Jul. 30, 2004, the contents of which are incorporated herein for reference.

1. A sound apparatus, comprising:
a correction unit that includes an input section for inputting an electric signal and a correction section for correcting a sound signal based on the electric signal inputted to the input section; and
a connection unit that connects a speaker to the input section of the correction unit.

2. The sound apparatus as set forth in claim 1, wherein the correction unit includes an output section for outputting the sound signal corrected by the correction section; and
wherein the connection unit is configured to switch the speaker between an input connection for connecting the speaker to the input section and an output connection for connecting the speaker to the output section.

3. The sound apparatus as set forth in claim 1, wherein the electric signal inputted to the input section from the speaker corresponds to a test sound which is received by the speaker and is outputted from other speaker; and
wherein the other speaker is not connected to the input section of the correction unit.

4. The sound apparatus as set forth in claim 1, wherein the correction unit includes a calculation section for calculating a resonance characteristic of the speaker by using the electric signal from the speaker; and
wherein the correction section corrects the sound signal outputted from a sound source based on the resonance characteristic.

5. A vehicle comprising the sound apparatus according to claim 1.

6. A sound system, comprising:
a sound source;
a first speaker;
a correction unit that is connected to the first speaker;
wherein the correction unit corrects a sound signal from the sound source based on an electric signal inputted from the first speaker.

7. The sound system as set forth in claim 6, further comprising a connection unit that connects the correction unit to the first speaker,
wherein the correction unit includes an input section for inputting the electric signal and an output section for outputting the corrected sound signal; and
wherein the connection unit is configured to switch the first speaker between an input connection for connecting the first speaker to the input section and an output connection for connecting the first speaker to the output section.

8. The sound system as set forth in claim 6 further comprising a second speaker that outputs a test sound,
wherein the electric signal inputted to the correction unit from the first speaker corresponds to the test sound which is received by the first speaker.

9. The sound system as set forth in claim 6, wherein the correction unit includes a calculation section for calculating a resonance characteristic of the first speaker by using the electric signal from the first speaker; and
wherein the correction section corrects the sound signal outputted from the sound source based on the resonance characteristic.

10. A method of correcting a sound signal, comprising:
providing a correction unit that includes an input section, an output section, and a correction section;
connecting a speaker to the input section;
receiving a test sound by the speaker;
inputting an electric signal that corresponds to the test sound, into the input section;
correcting a sound signal from a sound source based on the inputted electric signal; and
outputting the corrected sound signal.

11. The method as set forth in claim 10, further comprising:
switching the speaker between an input connection for connecting the speaker to the input section and an output connection for connecting the speaker to the output section.

12. The method as set forth in claim 10, further comprising:
outputting a signal for connecting the speaker to the input section for correcting the sound signal; and
outputting a signal for a request of outputting the test sound from a different speaker being not connected to the input section.

13. The method as set forth in claim 10, further comprising:
calculating a resonance characteristic of the speaker by using the electric signal from the speaker; and
correcting the sound signal outputted from the sound source based on the resonance characteristic.

14. A vehicle comprising the sound apparatus according to claim 2.

15. A vehicle comprising the sound apparatus according to claim 3.

16. A vehicle comprising the sound apparatus according to claim 4.
